(19) United States
(12) Patent Application Publication
(10) Pub. No.: US 2017/0026721 A1
(43) Pub. Date: Jan. 26, 2017

(54) System and Methods Thereof for Auto-Playing Video Content on Mobile Devices

(71) Applicant: Ani-View Ltd., Herzliya (IL)

(72) Inventors: Tal Melenboim, Ashdod (IL); Itay Nave, Herzliya (IL)

(21) Appl. No.: 14/966,472

(22) Filed: Dec. 11, 2015

Related U.S. Application Data
(60) Provisional application No. 62/180,632, filed on Jun. 17, 2015.

(51) Int. Cl. H04N 21/854; H04N 21/438; H04N 21/61; H04N 21/262; H04N 21/6543; H04N 21/84

(52) U.S. Cl. CPC H04N 21/85406; H04N 21/6543; H04N 21/84; H04N 21/6125; H04N 21/262; H04N 21/4382

(57) ABSTRACT

A system is configured to auto-play video content item on a web-page displayed on a mobile device. The system receives a request to auto-play the video content item on a display of the mobile device. The system fetches the video content item and identifies a type of the video content item. The system selects and initializes a codec to decode the video content item to a set of frames. The system then draws the set of frames on a draw area respective of the video content item. The system generates a display schedule for auto-playing the set of frames as video content item on the display of the mobile device. Then, the system displays the set of frames on the mobile device respective of the display schedule.

### TECHNICAL FIELD

The disclosure generally relates to systems for playing video content, and more specifically to systems and methods for displaying video content items on a variety of user devices.

### DESCRIPTION OF THE BACKGROUND

The Internet, also referred to as the worldwide web (WWW), has become a mass media where the content presentation is largely supported by paid advertisements that are added to web-page content. Typically, advertisements displayed in a web-page contain video elements that are intended for display on the user's display device.

Mobile devices such as smartphones are equipped with mobile browsers through which users access the web. Such mobile browsers typically cannot display auto-played video clips on mobile web pages as the mobile HTML5 video component does not allow autoplay and requires user interaction such as clicking on the page in order to start the video play. The term autoplay refers to starting playing a video on an HTML page when the page is loaded without requiring a user interaction such as clicking on the page. Furthermore, there are multiple video formats supported by different phone manufacturers which make it difficult for the advertisers to know which phone the user has, and what video format to broadcast it with.

It would therefore be advantageous to provide a solution that would overcome the deficiencies of the prior art by providing a unitary video clip format that can be displayed on mobile browsers.

### BRIEF DESCRIPTION OF THE DRAWINGS

The subject matter that is regarded as the disclosure is particularly pointed out and distinctly claimed in the claims at the conclusion of the specification. The foregoing and other objects, features and advantages of the disclosure will be apparent from the following detailed description taken in conjunction with the accompanying drawings.

FIG. 1—is a system for displaying video content on a display of a user device according to an embodiment;

FIG. 2—is a flowchart of the operation of a system for displaying video content on a display of a user device according to an embodiment;

FIG. 3—is a schematic diagram of an agent installed on the user device for displaying video content on a display unit of the user device; and,

FIG. 4—is a simulation of the operation of a system for displaying video content on a display of a user device according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

A system is configured to auto-play a video content item on a web-page displayed on a mobile device. The system receives a request to auto-play the video content item on a display of the mobile device. The system fetches the video content item and identifies a type of the video content item. The system selects and initializes a codec to decode the video content item to a set of frames. The system then draws the set of frames on a draw area respective of the video content item. The system generates a display schedule for auto-playing the set of frames as video content item on the display of the mobile device.

Then, the system displays the set of frames on the mobile device respective of the display schedule. In one exemplary embodiment, the draw area can be implemented using an HTML5 canvas. In another exemplary embodiment, the draw area may be implemented as an animated gif file. As yet another exemplary embodiment, the draw area can be implemented using webGL or any other means to draw an image on a display.

In order to render a video on a device without pre-processing the video in advance, it is helpful to decode the video frames in real time. This process is executed by a codec. The current disclosure discloses execution of a codec module in the context of the browser as part of the agent script that is included in the web page. In other words, the web page may include instructions that requests selection of the codec, and the browser may request selection of the code upon processing the web page. Such codec is responsible for generating frames out of the video files and the notion of a video codec that decodes the video in real-time is further described herein below.

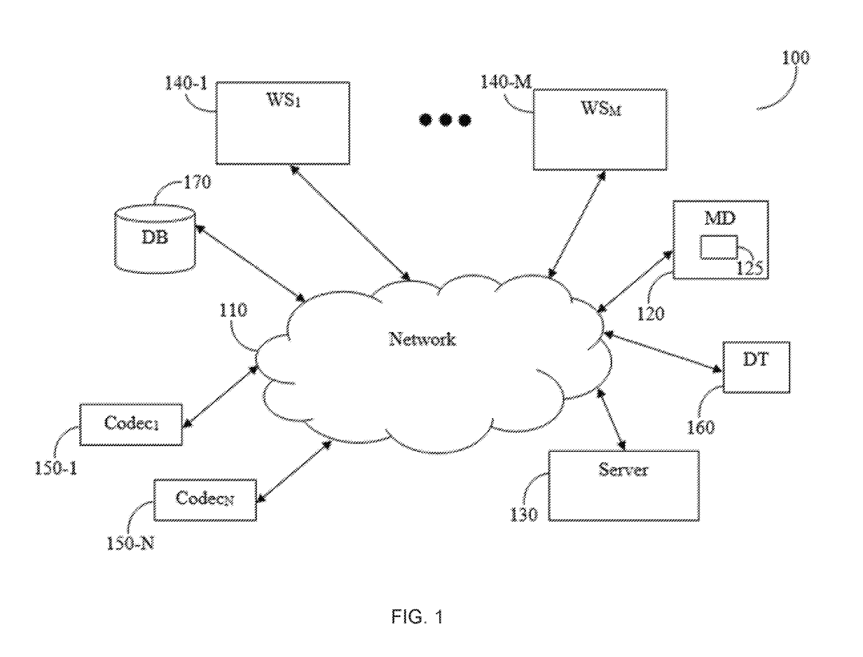

FIG. 1 depicts an exemplary and non-limiting diagram of a system 100 for displaying an auto-played video content item on a web-page display on a mobile device according to an embodiment. The system 100 comprises a network 110 that enables communications between various portions of the system 100. The network 110 may comprise the likes of busses, local area network (LAN), wide area network (WAN), metro area network (MAN), the worldwide web (WWW), the Internet, as well as a variety of other communication networks, whether wired or wireless, and in any combination, that enable the transfer of data between the different elements of the system 100. The system 100 further comprises a mobile device 120 connected to the network 110. The mobile device 110 may be, for example but without limitations, a smart phone, a mobile phone, a tablet computer, a wearable computing device and the like. The mobile device 120 comprises a display unit 125 such as a screen, a touch screen, etc.

A server 130 is further connected to the network 110. The system 100 further comprises one or more web sources 140-1 through 140-M (collectively referred hereinafter as web sources 140 or individually as a web source 140, merely for simplicity purposes), where M is an integer equal to or greater than 1. The web sources 140 may be web pages, websites, etc., accessible through the network 110. The web sources 140 may be operative by one or more publisher servers (not shown). The server 130 is configured to receive a request to display auto-played video content in a web-page displayed on the display unit 125 of the mobile device 120. According to one embodiment, the request may be received as a user's gesture over the display unit 125 of the mobile device 120.

The request may be identified as part of an analysis by the server 130 of the web-page to be displayed on the mobile device 120. Auto-play videos, in web-pages such as hypertext markup language (HTML) etc., will automatically start playing as soon as it can do so without stopping. In mobile devices, the operating systems (OSs) typically cannot display such auto-play content. According to another embodiment, the request may be received through an application program, such as an agent, installed on the mobile device 120.

Respective of the request, the server 130 is configured to fetch the at least one video content item from a web source, for example the web source 140-1. The request may include additional metadata that assists in the identification of a type of the at least one video content item.

According to an embodiment, the server 130 is further configured to identify a type of the mobile device 120 over which the at least one video content item is to be displayed. The type may include a configuration of the mobile device 120, an operating system of the device (e.g., Android, iOS, Windows, etc.), a display size, a display type, rendering capability of the mobile device 120, a list of applications locally installed on the mobile device 120, and so on. The type of the mobile device 120 may further include a form factor of the mobile device 120 (e.g., a smartphone or a tablet device).

The server 130 is further configured to identify a type of the at least one video content item, i.e, the video file format, e.g, MP4, MOV, MPEG, M4V, etc. The file type is identified by analyzing the metadata associated with the video content item. The metadata may include, for example, container data, video data, audio data, textual data and more. Container data may include, for example, a format, profile, commercial name of the format, duration, overall bit rate, writing application and library, title, author, director, album, track number, etc. Video data may include, for example, video format, codec identification data, aspect, frame rate, bit rate, color space, bit depth, scan type, scan order, etc. Audio date may include, for example, audio format, audio codec identification data, sample rate, channels, language, data bit rate, etc. Textual data may include, for example, textual format data, textual codec identification data, language of subtitle, etc.

The server 130 is then configured to select at least one codec out of a plurality of codecs 150-1 through 150-N (collectively referred hereinafter as codecs 150 or individually as a codec 150, merely for simplicity purposes), where N is an integer equal to or greater than 1. The codec 150 is an electronic circuit or software that enables manipulation of video content such as, for example, compression and/or decompression of video content, conversion of video content to different file types, encoding and/or decoding of video content, etc. Different types of video content items require different codecs and therefore the selection of the appropriate codec is required in order to generate display video content on a variety of operating systems of mobile devices. In other words, a first type of video content item may be associated with and processed by a first code, while a second type of video content item may be associated with and processed by a second codec. Furthermore, the operation of the system 100 enables auto-play of the video content as the frames of the original video content are consequently displayed on the mobile device 120 as further described herein below.

Following the selection of the at least one codec, for example, the codec 150-1, the server 130 initializes the codec 150-1 to decode the video content item. The codec then generates a set of frames respective of the at least one video content item. The codec 150-1 processes the at least one video content item by one or more computational cores that constitute an architecture for generating the set of frames respective thereof. According to an embodiment, the processing may include breaking down of the video content to frames. The codec 150-1 then determines for each element within each frame a token.

The server 130 then configures a virtual drawing tool 160 to draw the set of frames on a draw area. The draw area may be, for example, a draw area. Even though described separately, the codec may comprise the virtual drawing tool 160 therein.

The server 130 then generates a display schedule for displaying the plurality of frames as video content on the display unit 125 of the mobile device 120. The display schedule comprises a plurality of timer events initialized to initiate a plurality of codes that is used to decode and display the frames. Such schedule is defined based on the video attributes such as frames per second and the capabilities of the device to render frames in that Frames per Second—for example, if the frames per second of a video is 50 frames per second, one device may be capable to render 50 frames per second while another device may be able to render only 25 frames per second. The capabilities of the device may be discovered based on the Hardware and Software capabilities of the device such as ability to use Hardware rendering, CPU power, Memory, WebGL support, etc. Such timer events can be implemented, for example, by using setTimeout, setInterval, requestAnimationFrame that can be used to schedule code execution, etc. The code identifies a time metadata respective of the display of the video content and a corresponding frame to be displayed. As an example, if the video is configured to display 10 frames every second and the video was started 1.5 seconds ago, then frame 15 will be displayed. For example, the mobile device 120 may determine a duration that the video content has played. The mobile device 120 may then select a frame from the set of frames based on the duration that the video content has been playing, and based on a time associated with the selected frame from the display schedule.

As another example, an HTML5 audio component initialized with the audio track included in the video may be started in parallel to the video content and the code identifies the time of the video by accessing the currentTime property of the HTML5 audio content. Then a frame that should be displayed, according to the display schedule, at the time identified by the CurrentTime property of the audio is selected respective thereof. For example, the mobile device 120 may determine a duration that audio for the video content item has been playing based on the CurrentTime property of the audio (e.g., data that indicates how long the audio has been playing, such as a timestamped location in the audio). The mobile device 210 may select a frame from the set of frames based on the duration that the audio for the video content item has been playing and based on a time associated with the selected frame from the display schedule. For example, if the audio has been playing 2 seconds, the mobile device 120 would select the frame that is assigned to be displayed at 2 seconds, according to the schedule. According to one embodiment, the display schedule is generated respective of the type of the mobile device 120 and/or the display unit 125. As a non-limiting example, upon determination by the server 130 that the mobile device 120 is a smart phone, a display schedule of ten images per second is determined while upon determination that the mobile device 120 is a PC, a display schedule of 20 images per second is determined. In other embodiment the display schedule includes 15 images per 2 seconds. The set of frames and the display schedule are then sent by the server 130 to the mobile device 120. The system 100 further comprises a database 170. The database 170 is configured to store data related to the fetched video content, sets of frames, etc. The display schedule and the frame timing included therein may be generated by the codec, which is specific to the type of device. In other words, each of the codecs may be able to generate multiple different frame timings for a given video content item based on the type of device on which the video content item will be displayed.

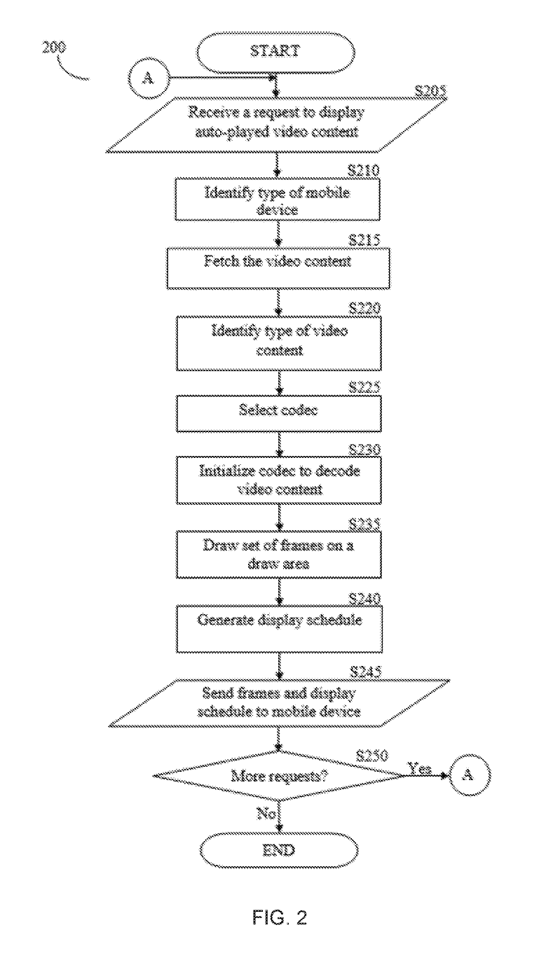

FIG. 2 is an exemplary and non-limiting flowchart 200 of the operation of displaying an auto-played video content on a display of a user device according to an embodiment. In S205, the operation starts when a request to display an auto-played video content item on the mobile device 120 is received. According to an embodiment, the request may be to stream video content to the mobile device 120.

In streaming, the video content item is delivered and displayed on the mobile device 120 through the web source 140. The verb “to stream” refers to a process of delivering the video content in this manner; the term refers to the delivery method of the medium, rather than the medium itself, and is an alternative to downloading.

In optional 5210, a type of the mobile device 120 is identified by the server 130. The type may include a configuration of the mobile device 120, an operating system of the device (e.g., Android, iOS, Windows, etc.), a display size, a display type, rendering capability of the mobile device 120 and so on. The type of the mobile device 120 may include a form factor of the mobile device 120 (e.g., a smartphone or a tablet device). In S215, the requested video content is fetched from a web source 140-1 through the network 110. The web source 140-1 is accessible by the server 130 over the network 110.

In S220, a type of the fetched video content item is identified by the server 130 as further described hereinabove with respect of FIG. 1. In S225, at least one codec of the plurality of codecs 150 is selected. The selection of the codec is made respective of the type of the video content item, i.e, certain file formats may require different decoding and therefore different codecs.

In S230, the at least one selected codec, for example the codec 150-1 is initialized by the server 130 to decode the video content item to a set of frames. In S235, the set of frames is drawn on a draw area respective of the video content item. In S240, a display schedule for displaying each of the frames of the set of frames is generated. In S245, the set of frames and the display schedule are sent to the mobile device 120. In S250, it is checked whether additional requests for video content are received from the mobile device 120 and if so, execution continues with 5210; otherwise, execution terminates.

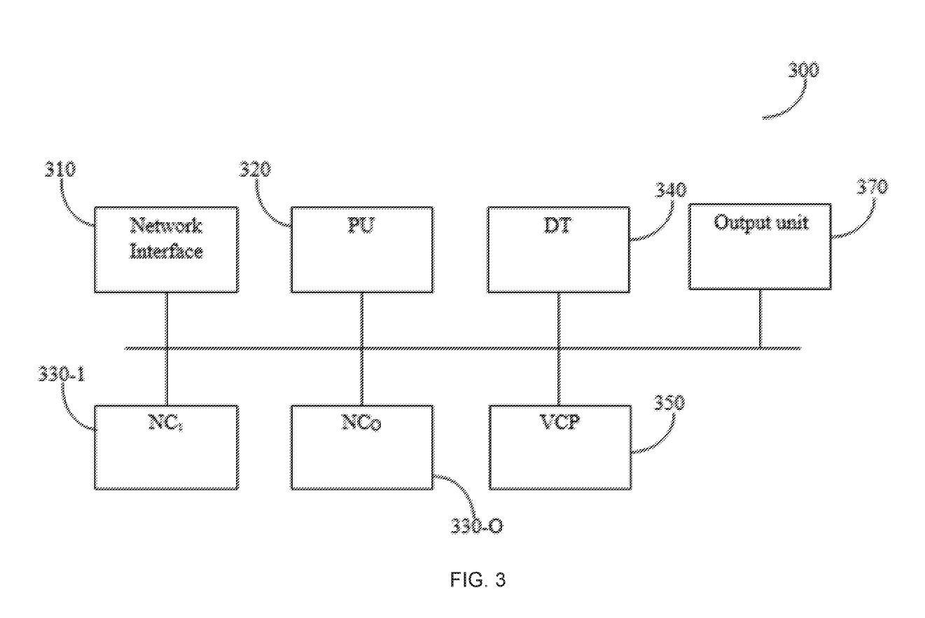

FIG. 3 depicts an exemplary and non-limiting schematic diagram of an agent 300 installed on the mobile device 120 for displaying auto-played video content on a web-page displayed on the mobile device 120. The agent 300 is loaded when an HTML page is loaded and upon page loading the agent 300 receives a request for displaying the auto-played video content on a web-page displayed on the mobile device 120. The agent 300 uses the interface 310 to fetch the video content item requested to be displayed on the display unit 125 of the mobile device 120 and its respective metadata.

The agent 300 further comprises a processing unit (PU) 320 configured to process the fetched video content item and its respective metadata and identify the type of the video content item respective thereof. The agent 300 further comprises one or more native codecs 330-1 through 330-O (collectively referred hereinafter as native codecs 330 or individually as a native codec 330, merely for simplicity purposes). It should be noted that native in this respect does not refer to native code, but rather to the codec script disclosed herein where O is an integer equal to or greater than 1. The native codec (NC) 330 is configured to decode a set of frames respective of the at least one video content item.

The agent 300 further comprises a drawing tool (DT) 340, the drawing tool 340 is configured to draw the set of frames on a draw area 350 respective of the video content item. The processing unit 320 is further configured to generate a display schedule for displaying the set of frames as video content on the display unit 125. The agent 300 further comprises an output unit 370 for auto-playing the set of frames on the display unit 125 respective of display schedule.

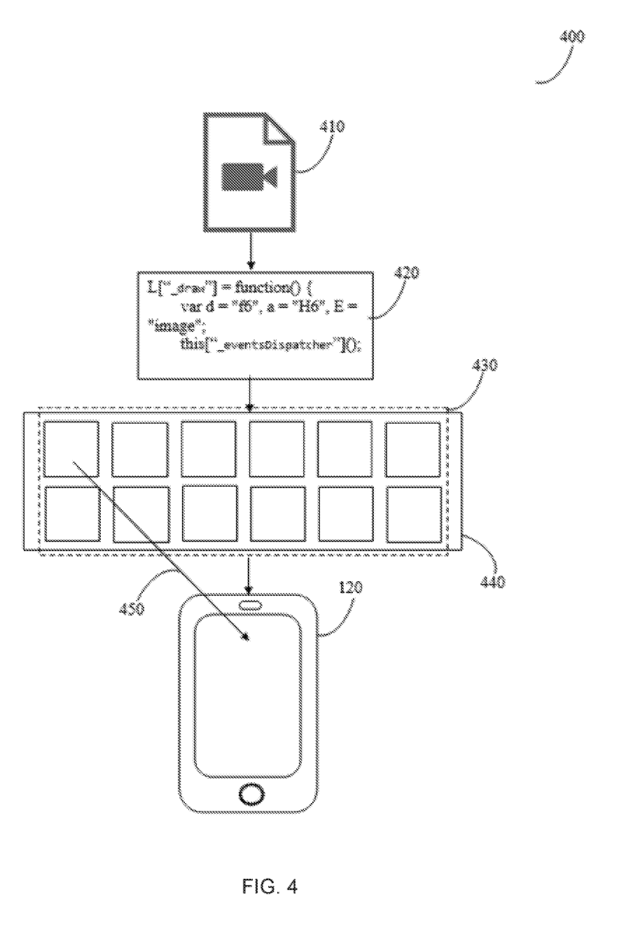

FIG. 4 depicts an exemplary and non-limiting simulation 400 of the operation of a system for displaying auto-played video content on a web-page displayed on the mobile device according to an embodiment. The video content item 410 is processed by the codec 150, resulting in a generation of a set of frames 320 respective of the video content item 410. The set of frames 420 is then drawn 430 on a draw area 440. Then, respective of the display schedule determined, the set of frames is auto-played 450 in real time on the display unit 125 of the mobile device 120.

The principles of the disclosure, wherever applicable, are implemented as hardware, firmware, software or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program embodied in non-transitory computer readable medium, or any combination thereof, which may be executed by a CPU, whether or not such computer or processor is explicitly shown. Implementations may further include full or partial implementation as a cloud-based solution. In some embodiments certain portions of a system may use mobile devices of a variety of kinds. In addition, various other peripheral units may be connected to the computer platform such as an additional data storage unit and a printing unit. The circuits described hereinabove may be implemented in a variety of manufacturing technologies well known in the industry including but not limited to integrated circuits (ICs) and discrete components that are mounted using surface mount technologies (SMT), and other technologies. The scope of the disclosure should not be viewed as limited by the SPPS 110 described herein and other monitors may be used to collect data from energy consuming sources without departing from the scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for auto-playing a video content item in a web-page of a mobile device, the method comprising:
receiving a request to auto-play the video content item in the web-page displayed on the mobile device;
fetching the video content item and respective metadata;
identifying a type of the video content item by analyzing the metadata;
selecting at least one codec respective of the type of the video content item;
initializing the at least one codec to decode the video content item to a set of frames;
generating a display schedule for displaying the set of frames on the mobile device;
drawing the set of frames on a draw area respective of the at least one video content item; and
auto-playing the set of frames respective of the display schedule.

2. The computerized method of claim 1, wherein the mobile device is one of: a smart phone, a mobile phone, a tablet computer, a wearable computing device.

3. The computerized method of claim 1, wherein the draw area comprises of at least one of: a canvas, a GIF, a BITMAP, and a WEBGL.

4. The computerized method of claim 1, wherein the metadata includes the frames per second of the video.

5. The computerized method of claim 4, wherein the display schedule comprises time metadata respective of a display time of each frame based on the frames per second metadata included in the metadata.

6. The computerized method of claim 1, wherein playing an audio is initiated in parallel to playing the video.

7. The computerized method of claim 6, wherein the display schedule is determined based on a current time property of the audio.

8. The computerized method of claim 1, further comprising:
identifying a type of the mobile device; and,
generating a display schedule for auto-playing the set of frames as video content on the mobile device respective of the type of the mobile device.

9. The computerized method of claim 1, wherein auto-playing the set of frames respective of the display schedule comprises:
determining a duration that audio for the video content item has been playing based on a current time property of the audio;
selecting a frame from the set of frames based on the duration that the audio for the video content item has been playing and based on a time associated with the selected frame from the display schedule; and
displaying the selected frame.

10. A non-transitory computer readable medium having stored thereon instructions for causing one or more processing units to execute operations that include:
receiving a request to auto-play the video content item in the web-page displayed on the mobile device;
fetching the video content item and respective metadata;
identifying a type of the video content item by analyzing the metadata;
selecting at least one codec respective of the type of the video content item;
initializing the at least one codec to decode the video content item to a set of frames;
generating a display schedule for displaying the set of frames on the mobile device;
drawing the set of frames on a draw area respective of the at least one video content item; and
auto-playing the set of frames respective of the display schedule.

11. A mobile device having installed thereon an agent configured to auto-play a video content item in a web-page of a mobile device, the agent comprising:
an interface for receiving a request to auto-play the video content item in the web-page displayed on the mobile device;
a plurality of codecs;
a draw area;
a drawing tool;
a processing unit connected to the interface;
a memory connected to the processing unit, the memory containing instructions therein that when executed by the processing unit configure the agent to:
fetch the video content item and respective metadata from a web source over a network;
analyze the metadata;
identify a type of the video content item respective of the analysis;
select at least one codec of the plurality of codecs respective of the type of the video content item;
initialize the at least one codec to decode the video content item to a set of frames;
draw the set of frames on a draw area respective of the at least one video content item;
generate a display schedule for displaying the set of frames as video content on the mobile device; and
auto-play the set of frames as video content on the web-page respective of the display schedule.

12. The mobile device of claim 11, wherein the mobile device is one of: a smart phone, a mobile phone, a tablet computer, and a wearable computing device.

13. The mobile device of claim 11, wherein the metadata is at least one of: container data, video data, audio data, and textual data.

14. The mobile device of claim 13, wherein the metadata is container data, and the container data is at least one of: a format, profile, commercial name of the format, duration, overall bit rate, writing application and library, title, author, director, album, and track number.

15. The mobile device of claim 13, wherein the metadata is video data and the video data is at least one of: a video format, codec identification data, aspect, frame rate, bit rate, color space, bit depth, scan type, and scan order.

16. The mobile device of claim 13, wherein the metatdata is audio data and the audio data is at least one of: audio format, audio codec identification data, sample rate, channels, language, and data bit rate.

17. The mobile device of claim 13, wherein the metadata is textual data and the textual data is at least one of: textual format data, textual codec identification data, and language of subtitle.

18. The mobile device of claim 11, wherein auto-playing the set of frames as video content on the web-page respective of the display schedule comprises:
determining a duration that audio for the video content item has been playing based on a current time property of the audio;
selecting a frame from the set of frames based on the duration that the audio for the video content item has been playing and based on a time associated with the selected frame from the display schedule; and
displaying the selected frame.
